(19) United States
(12) Patent Application Publication
(10) Pub. No.: US 2007/0100260 A1
(43) Pub. Date: May 3, 2007

(54) Vibration body-pump device

(76) Inventor: Yu Sung Chiang, Chang Hua Hsien (TW)

Correspondence Address: Yu Sung Chiang, 235 Chung-Ho, Box 8-24, Taipei, TW

(21) Appl. No.: 11/262,449

(22) Filed: Oct. 31, 2005

(51) Int. Cl. A61H 1/00

(52) U.S. Cl. 601/49; 601/31; 601/90

(57) ABSTRACT

A vibration body-pump device comprises a slab, a link rod and an electric motor. The slab is for supporting hands or feet, supported by a hinge, and connected with an inversely triangular bracket. One end of the hinge is pivotally connected to the bracket and the other end to an eccentric wheel. The electric motor has an axial shaft coaxially attached with the eccentric wheel, whereby, as the motor is rotating, the eccentric wheel will move accordingly, and whereby the link rod will be driven to make the slab vibrate. Therefore, the body-pump device will shake the whole body by vibrating the hands or feet put on the slab, achieving an effect of body pump.

### FIELD OF THE INVENTION

The present invention relates to body-pump devices, more particularly to a vibration body-pump device that drives passive motion of the whole body of a user, thereby achieving an effect of body pump.

### BACKGROUND OF THE INVENTION

Body pump devices through vibrations are very popular nowadays. The principle of the devices is vibrating the whole body of a user through vibrating hands or legs, so that the body fatigue and stagnation of blood vessels can be eased, and the effect of losing weight can be attained. The conventional body pump devices are waist belt vibrator driven by an electric motor, which uses local vibrations and massage to illuminate body fat and fatigue; thereby, the muscles will become firm and the skin will be smooth. However, body pump devices of the prior art are not practical enough to fit modern women who care about their body shape.

### SUMMARY OF THE INVENTION:

The primary objective of the present invention is to provide a vibration body-pump device wherein the vibration strength can be arbitrarily adjusted, whereby the effect of removing body fat and losing weight can be effectively achieved.

The vibration body-pump device comprises a slab, a link rod and an electric motor. The upper surface of the slab supports hands or feet, and the bottom surface thereof is pivotally supported by an inversely disposed triangular bracket through a hinge. The link rod has one end connected to the bracket and the other end pivotally connected to an eccentric wheel. The electric motor has a central shaft coaxially attached with the eccentric wheel.

The connection means between the eccentric wheel and the motor can be either of the following mechanisms.

In the first mechanism, the eccentric wheel is coaxially fixed to the shaft of an electric motor, whereby, as the electric motor is rotating, the eccentric wheel will move accordingly and drive the slab to vibrate vertically through the link rod.

In the second mechanism, the eccentric wheel is coaxially fixed to the shaft of a rotary wheel, which is in turn coupled with the shaft of an electric motor by a transmission belt. Thereby, as the electric motor is rotating, the eccentric wheel will move accordingly and drive the slab to vibrate vertically through the link rod.

Further, the slab can be attached with a plurality ropes for balancing a user standing thereon and for effectively transmitting vibrations to the upper body as the lower body limbs are shaken by the slab. Thereby, a better massage effect can be achieved.

Further, the top surface of the slab can be provided with hand pads or foot pads for retaining the user's limbs.

The lower rim of the slab can be further provided with a cover for shielding the supporting structure under the slab.

When a body-pump device of the present invention is activating, a user can stand on the slab with a variety of postures, such as standing with one foot or both feet. As the slab is equipped with ropes, the user can hold the ropes to balance the body. And then the electric motor is activated to provide a rotation with a predetermined frequency that drives the slab to vibrate accordingly. The angular speed and the vibration strength can be adjusted by an electronic device to attain a desired body massage effect.

The various objects and advantages of the present invention will be more readily understood from the following detailed description when read in conjunction with the appended drawings.

### Brief Description of the Drawings

FIG. 1 is a side view of the first preferred embodiment of the present invention as a vibration body-pump device.

FIG. 2 illustrates the use of the first preferred embodiment of the present invention as a vibration body-pump device.

FIG. 3 is a side view of the second preferred embodiment of the present invention as a vibration body-pump device.

FIG. 4 illustrates the use of the second preferred embodiment of the present invention as a vibration body-pump device.

FIG. 5 illustrates the various uses of the present invention as a vibration body-pump device.

### Detailed Description of the Preferred Embodiments

(1) The First Preferred Embodiment

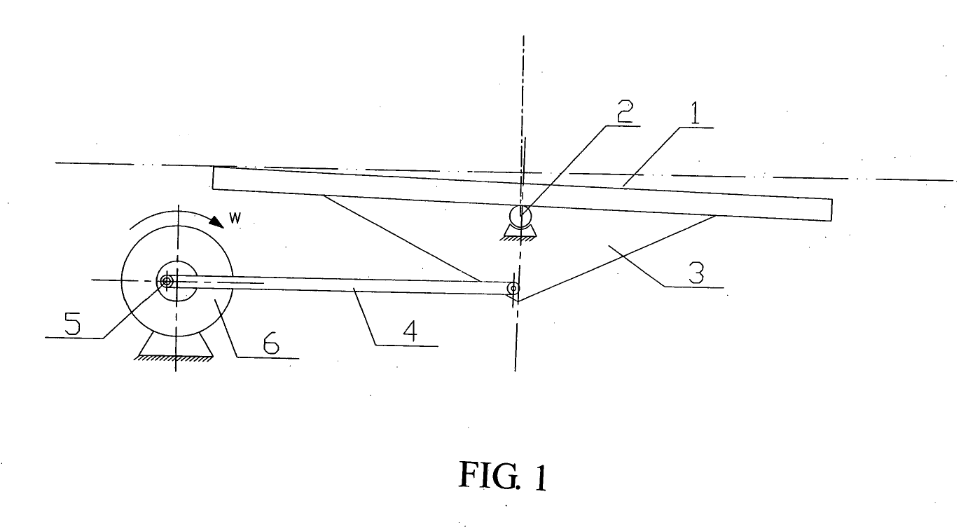

Referring to FIG. 1, the first preferred embodiment of the present invention as a vibration body-pump device comprises a slab 1, a link rod 4 and eccentric wheel 5. The upper surface of the slab 1 supports hands or feet, and the bottom surface thereof is pivotally supported by an inversely disposed triangular bracket 3 through a hinge 2. The link rod 4 has one end connected to the bracket 3 and the other end pivotally connected to an eccentric wheel 5. The preferred embodiment further includes an electric motor 6 having a central shaft coaxially attached with the eccentric wheel 5, whereby, as the electric motor 6 is rotating, the eccentric wheel 5 will move accordingly and drive the slab 1 to vibrate vertically through the link rod 4.

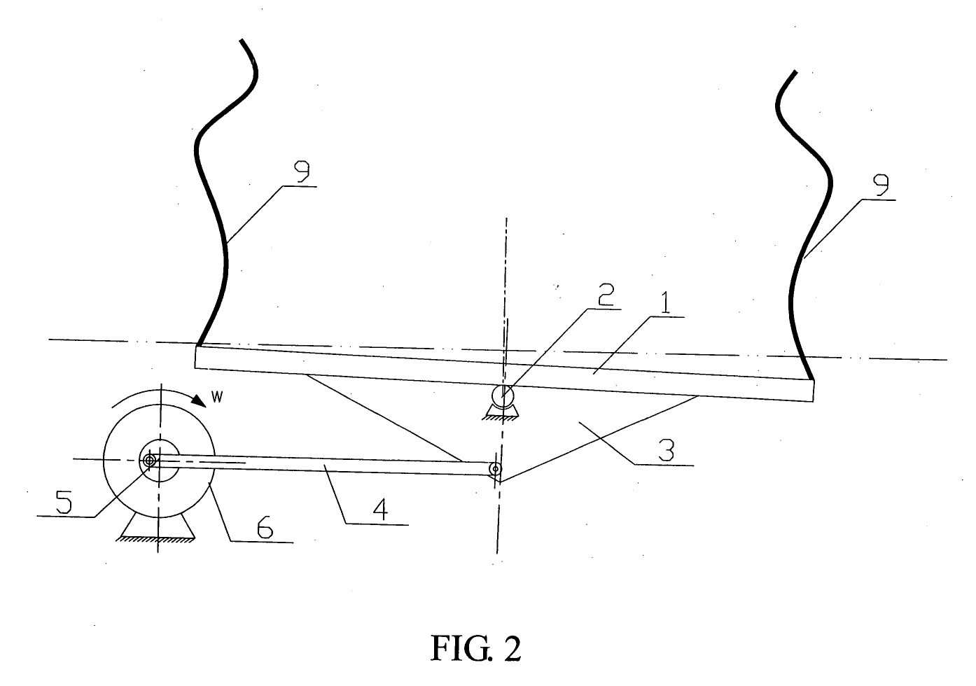

As shown in FIG. 2, the slab 1 of the first preferred embodiment can be further provided with a plurality of ropes 9 for balancing a person standing on the slab 1. Thereby, the vibrations of the slab 1 can be effectively transmitted from the lower limbs to the whole body, achieving a more effective massage effect.

(2) The Second Preferred Embodiment

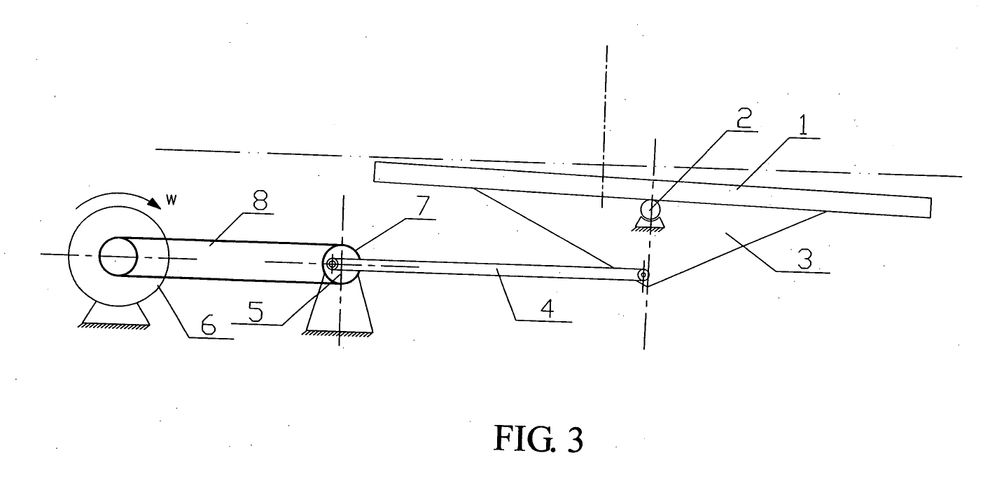

Referring to FIG. 3, the second preferred embodiment of the present invention as a vibration body-pump device comprises a slab 1, a link rod 4 and eccentric wheel 5. The upper surface of the slab 1 supports hands or feet, and the bottom surface thereof is pivotally supported by an inversely disposed triangular bracket 3 through a hinge 2. The eccentric wheel 5 is coaxially fixed to the shaft of a rotary wheel 7, which is in turn coupled with the shaft of an electric motor 6 by a transmission belt 8. Thereby, as the electric motor 6 is rotating, the eccentric wheel 5 will move accordingly and drive the slab 1 to vibrate vertically through the link rod 4.

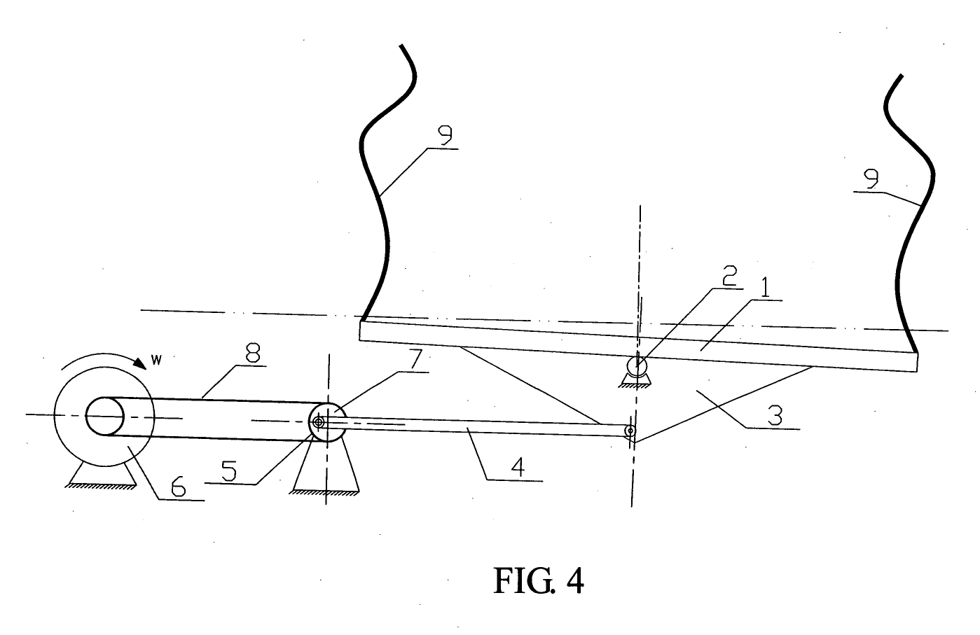

As shown in FIG. 4, the slab 1 of the first preferred embodiment can be further provided with a plurality of ropes 9 for balancing a person standing on the slab 1. Thereby, the vibrations of the slab 1 can be effectively transmitted from the lower limbs to the whole body, achieving a more effective massage effect.

Further, the top surface of the slab 1 can be provided with hand pads or foot pads for retaining the user's limbs, and the lower rim of the slab 1 can be further provided with a cover for shielding the supporting structure under the slab 1.

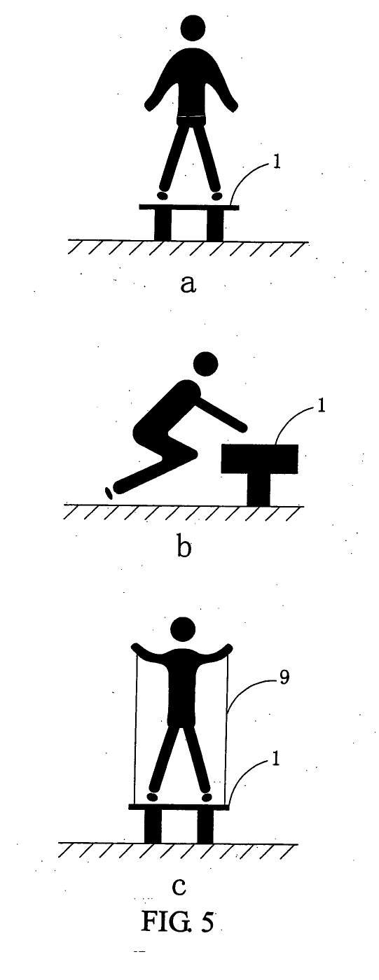

To use the present invention, a user can stand on the slab with a variety of postures, such as standing with one foot or both feet (as shown In FIG. 5). As the slab 1 is equipped with ropes 9, the user standing on the slab 1 can hold the ropes to balance the body. And then the electric motor 6 is activated to provide a rotation with a predetermined angular speed that drives the slab 1 to vibrate accordingly. The angular speed and the vibration strength can be adjusted by an electronic device to attain a desired whole-body massage effect.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vibration body-pump device, comprising:
a slab whose upper surface is for placing limbs selected from hands and legs, a lower surface of said slab is connected with an inversely triangular support bracket through a hinge;
a link rod with a first end connected to said support bracket and a second end to an eccentric wheel; and
an electric motor whose shaft is connected with said eccentric wheel.

2. The vibration body-pump device of claim 1 wherein said eccentric wheel is coupled coaxially with an axial shaft of said electric motor.

3. The vibration body-pump device of claim 1 wherein said eccentric wheel is coupled coaxially with an axial shaft of a rotary wheel which then connected with an axial shaft of said electric motor.

4. The vibration body-pump device of claim 1 wherein said slab has at least a pair of ropes.

5. The vibration body-pump device of claim 2 wherein said slab has at least a pair of ropes.

6. The vibration body-pump device of claim 3 wherein said slab has at least a pair of ropes.

7. The vibration body-pump device of claim 1 wherein said slab is provided with at least a pad for supporting body limbs selected from hands and feet.

8. The vibration body-pump device of claim 2 wherein said slab is provided with at least a pad for supporting body limbs selected from hands and feet.

9. The vibration body-pump device of claim 3 wherein said slab is provided with at least a pad for supporting body limbs selected from hands and feet.

10. The vibration body-pump device of claim 1 wherein a cover is extended downwardly from a circumference of said slab for covering said components beneath said slab.

11. The vibration body-pump device of claim 2 wherein a cover is extended downwardly from a circumference of said slab for covering said components beneath said slab.

12. The vibration body-pump device of claim 3 wherein a cover is extended downwardly from a circumference of said slab for covering said components beneath said slab.
